(19) United States
(12) Patent Application Publication
(10) Pub. No.: US 2020/0080753 A1
(43) Pub. Date: Mar. 12, 2020

(54) Green Cycle Heat Pump Engine

(71) Applicants: Darrell Henry Green, JR., Roseburg, OR (US); Christopher Lee Mercadal, Murrieta, CA (US); Amie Lyons, San Diego, CA (US)

(72) Inventors: Darrell Henry Green, JR., Roseburg, OR (US); Christopher Lee Mercadal, Murrieta, CA (US); Amie Lyons, San Diego, CA (US)

(21) Appl. No.: 16/122,899

(22) Filed: Sep. 6, 2018

(51) Int. Cl. F25B 9/14; F02G 1/043; F03G 7/06

(52) U.S. Cl. CPC F25B 9/14; F25B 2309/001; F03G 7/065; F02G 1/043

(57) ABSTRACT

A single piston (1), rotary displacer (2), heat cycle/transfer engine, using a fixed volume of working fluid, in a single L shape tubular chambered (10), three zone (7)(8)(9), sealed housing (3). The rotary displacer (2) consists of a displacer cam (4) and a crank shaft (5) supported by a variable number of rotary bearings (6), the number and type of which depends on the size and rotational speed of the completed unit. The sealed housing (3), consisting of three zones, where one faces a heat source side (7), one acts an insulating barrier (8) and one acts as a heat sink (9). Movement of the rotary displacer (2) transports the contained working fluid to the exposed surfaces of the heat source side (7) and the heat sink (9) sequentially, while the incorporated crank shaft (5) drives the single piston (1), via a connecting rod (11), which allows for the manipulation of the corresponding expansion and contraction of the working fluid. The engine can use the transfer of heat, the Carnot Heat Cycle, to generate rotational (or linear) power or act as a heat pump/refrigeration unit. When used to produce rotational power, the initial rotational energy may be provided by a loop of Nitinol (12) or similar shape memory alloy to avoid a stall caused by the working fluid being exposed to the heat source side and heat sink side equally. The Nitinol loop (12) may ride on a second shape memory alloy ring (14), which allows it to disengage at higher temperatures and rotational speeds, effectively acting as a clutching mechanism. The invention is scalable to include nano-devices and micro electromechanical systems (MEMS), through large scale heat recovery systems.

### CLASSIFICATIONS

F02G1/043 Hot gas positive-displacement engine plants of closed-cycle type the engine being operated by expansion and contraction of a mass of working gas which is heated and cooled in one of a plurality of constantly communicating expansible chambers

F25B9/14 Compression machines, plant, or systems, in which the refrigerant is air or other gas of low boiling point characterized by the cycle used

Y02E10/46 Conversion of thermal power into mechanical power, e.g. Rankine

F03G7/065 Mechanical-power-producing mechanisms, not otherwise provided for or using energy sources not otherwise provided for using expansion or contraction of bodies due to heating, cooling, moistening, drying or the like using a shape memory element

### BACKGROUND OF THE INVENTION

### Field of the Invention

The invention is related to a group of devices utilizing the Carnot heat cycle, where variations in the pressure of the working fluid is caused by exposure to an external heat source and a heat sink alternately. This group of devices is generally accepted to be heat cycle/transfer engines/systems. The invention may also be related to devices creating mechanical motion using a shape-memory element.

### Description of the Related Art

There are many sealed heat cycle engine designs in theory and several are currently in practice. The most common is the Stirling Engine (19ₜₕ Century). The basic premise of the heat cycle/transfer engine/system, in the mechanical type (containing moving parts), is the exposure of an expanding/contracting medium to a heat source and a heat sink via transfer of the medium and/or the surface exposures in a cyclical fashion while inducing a corresponding cyclical change in the containment's internal pressure. This process is a simplified, mechanical version of the modern heat pump cycle used in commercial and residential environment heating and cooling systems. The physics of the heat cycle/transfer engine are long proven and are, to present, still in use throughout the world for power generation, refrigeration and environment heating and cooling systems. This inventions design intent is to complete these same tasks more efficiently and economically, reducing the number of parts and minimizing production difficulties and expense.

Rotary processing of the heat transfer, using the minimum number of parts and the minimum amount of linear inertia, is theorized to be more efficient and cost effective in its proposed construction while allowing for a large range in sizing. This unit contains a rotary crank/cam driven by a piston inside a sealed, single, L-shaped chamber container. The size of the completed unit, type of working fluid, type of bearings, methods of external transfer of the rotational energy and the shape of the displacer cam and piston will be varied depending on the application.

The Stirling cycle and other heat cycle engines have been around for nearly two centuries. Over this time, little has been accomplished to make it markedly more versatile in its application. Steam engines and later internal combustion engines have, in their turn, taken the market and held it. However, due to the complexity of the internal combustion engine and the danger of the steam engine, the sealed heat cycle engine has held a niche for applications needing multiple fuel types, low temperature differences or the use of external heat sources. It has also been successful in holding on to a portion of the refrigeration and air conditioning markets in its use as a heat pump. In its ability to perform energy transformation at low temperature differentials, it can be used as a primary or secondary transformer. Because of this, it can be an additive to other current energy generation mechanisms that have waste heat that can be used in a heat transfer cycle. The heat cycle/transfer engine has an incredible potential to fulfill very unique tasks in the field of renewable energy if it is not cost prohibitive in its design. This invention provides the ability to apply a heat cycle/transfer solution to numerous situations with significantly lower production cost than previous designs while also allowing for miniaturization due to its minimal number of parts.

The device may also utilize a loop of Nitinol or other shape-memory alloy to initiate rotary motion when exposed to changes in temperature while previously being in a static state. Nitinol, and other shape-memory alloys, have a unique property where their shapes can be dissimilar at different temperatures. These shapes are near static in nature and are not directly associated with expansion and contraction, but rather with a changing crystalline internal structure. When produced and formed at specified temperatures these metals can be trained to be in one shape at a given temperature range but malformed or trained to a second shape outside that temperature range. Returning the metal to the initial temperature range causes the crystalline structure to return to its initial trained shape. Several ranges can be induced allowing the shape to be somewhat controlled at several different temperature ranges. The original discovery of this grouping of metals, those falling in the category of shape-memory alloy, is credited to scientists as far back as 1932 but the modern working alloys were discovered by William Beuhler, who worked at the US Naval labs in 1962.

### SUMMARY OF THE INVENTION

The following examples are some of the embodiments of the invention, presented with the intention of showing the vast array of possible scenarios where the invention can be used as a heat transfer engine or a heat pump or a combination of both.

Example 1: as a heat pump/refrigerant unit attached to the body of a drinking/eating vessel (e.g. cup, bowl, food storage container etc.) where the invention acts as a heater or a cooler of the enclosed.

Example 2: as a heat pump/refrigerant unit attached to the human body via a thermal contact, powered by a second unit (acting as a heat engine) or powered by an external or internal secondary power source where the invention acts as a heater or cooler for the human body.

Example 3: as a heat engine, driving an electrical generator, powering remote sensing units that require a localized power source.

Example 4: as a heat engine, driving an electrical generator, when powered by an outside heat source, where the heat source can be the surrounding air, water, solar, waste heat, or applied fuel, or where a cooling influence is added to the heat sink side, where the cooling influence can be the surrounding air, water, soil, ice or numerous other heat sinks.

Example 5: as a heat engine, driving an electrical generator, when powered by an outside heat source, where the heat source can be the human body or other biological source.

Example 6: as a heat engine, driving a fluid pump, either directly or indirectly, where the heat sink side is being cooled by the fluid being pumped, or the heat source side is being heated by the fluid being pumped, or both, where the engine acts as an integral part of a larger heat pump system for a residence.

Example 7: as a heat pump/heat engine radiator, where the initial heat difference drives the rotary motion that then drives a fan or a circulation pump that assists in transferring heat off of the heat sink; allowing the heat source to power the radiation of its heat in a much expedited fashion; where the invention is used as a radiator system for industrial engines (e.g. military automotive equipment used in tropical environs).

Example 8: as a stacked, extreme efficiency electrical or rotary motion generator, where several units of the invention are stacked to maximize the transfer of heat to another form of useful energy, when the heat source is at a premium (e.g. satellite power source, other space mission related energy sources).

### BRIEF DESCRIPTION OF THE DRAWING FIGURES

FIG. 1 is a perspective, exploded drawing of the invention in its entirety.

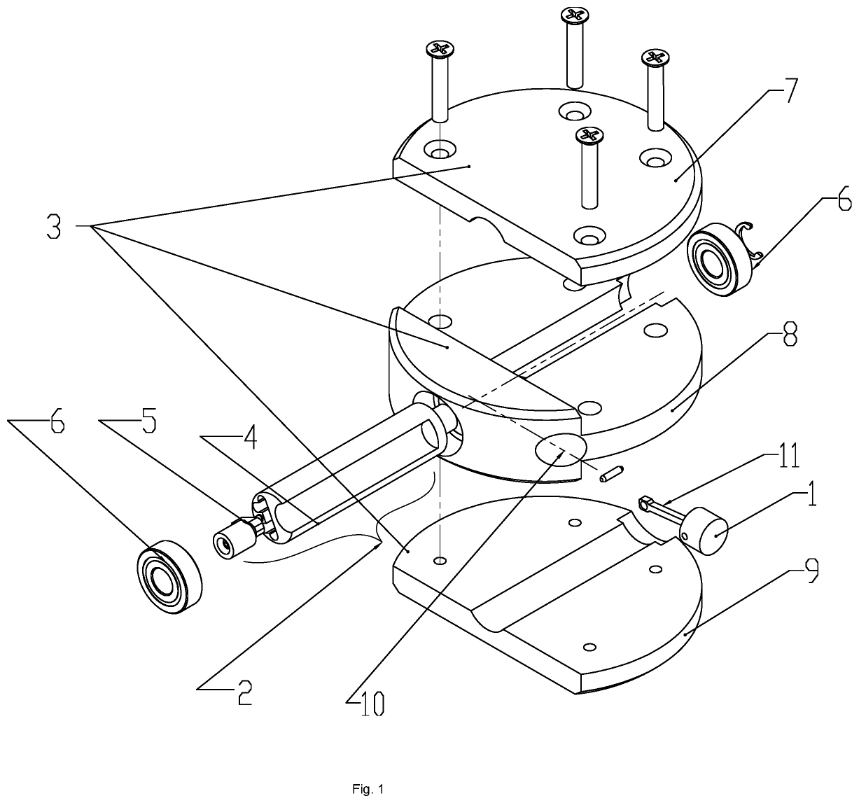

FIG. 2 is a perspective, exploded drawing of the invention, showing the position of the shape-memory alloy and its relation to the whole, for any embodiment utilizing the initial rotary motion provided by the shape-memory alloy.

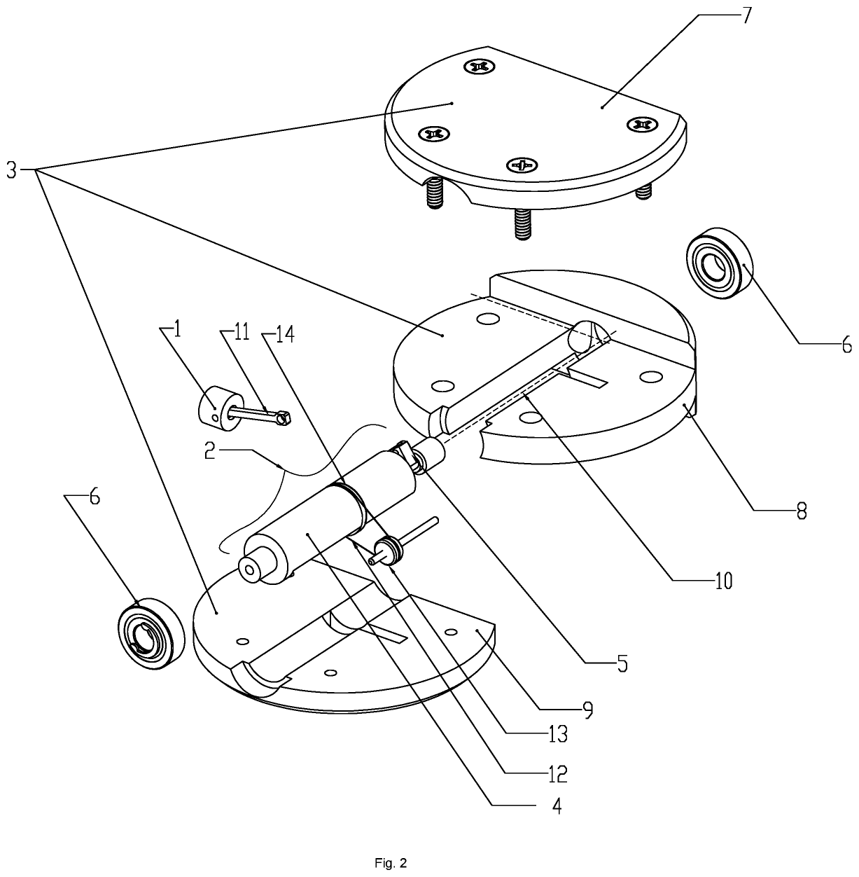

### DETAILED DESCRIPTION OF THE PREFERRED EMBODIMENT (S)

The number of pistons will depend on the application. However, the design may use a single piston (1) to manipulate the available volume within the chamber (10). The piston (1) is attached to a connecting rod (11) connected to a crank shaft (5)-cam shaft (4) combination (described here as rotary displacer) (2). The piston's (1) shape may vary due to size and application and may be a tympanic drum. The piston (1) resides in a channel perpendicular to the chamber containing the crank shaft (5)-cam shaft (4) rotary displacer (2). The piston (1) may extend when driven by an expansion of the working fluid during use as a rotary power generator or may extend due to mechanical propulsion to create a low pressure in the working fluid when used as a heat pump. The piston (1) may retract when allowed by a low pressure when used as a rotary generator or may retract due to mechanical propulsion to create a high pressure in the working fluid when used as a heat pump. The cam (4) of the rotary displacer (2) is shaped in such a way as to nearly conform to the shape of its tubular containment chamber (10) with the exception of one shallow area along its length. This allows the cam (4) to capture and contain the working fluid within the shallow area only, while driving it away from the remaining surface area of the tubular chamber (10). This allows the circular rotation of the cam (4) to transport the working fluid to the different zones (7) (9). Following the Carnot cycle, the working fluid is exposed to the heat source side (7) when the piston (1) is immediately past its fully retracted position and while continuing through its fully extended position. The working fluid is then exposed to the heat sink (9) when the piston (1) is immediately past its fully extended position through its fully contracted position. This movement continues the exposure of the working fluid to the different zones (7) (9) in consecutive cycles. This action allows the engine to use the external heat source to provide expansion of the working fluid, transferring this added heat to the heat sink (9) via circular rotation of the main shaft (2) and its exposure thereto. This action also allows the mechanical manipulation of the rotation via a power source driving the main shaft (2) where the piston's (1) increasing and decreasing of the internal pressure allows for the use of the thermodynamic relationship to move heat from one zone (7) to the other (9) via a heat pump cycle. When used to produce rotational power, the initial rotational energy may be provided by the expansion/contraction of a closed loop of Nitinol (12) spiraled wire, or similar shape-memory alloy, to avoid a stall caused by the working fluid being exposed to the heat source side and heat sink side equally. The loop of Nitinol (12) spiraled wire, or similar shape-memory alloy, may encompass the crank shaft-displacer cam combination, exposing the memory allow to the heat source side, at one extreme, and encompass a rotary pin (13) positioned in the heat sink side, at the other extreme, exposing the shape-memory alloy to the heat sink. The Nitinol loop (12) will ride on a second shape-memory alloy ring (14), which allows it to disengage at higher temperatures and rotational speeds.

### PATENT CITATIONS

US20050166601A1*2004 Feb. 3 2005 Aug. 4 The Coleman Company, Inc. Portable insulated container incorporating stirling cooler refrigeration

U.S. Pat. No. 4,055,955A*1976 Aug. 16 1977 Nov. 1 Alfred Davis Johnson Memory alloy heat engine and method of operation

U.S. Pat. No. 4,965,545A*1989 Aug. 9 190 Oct. 23 Tini Alloy Company Shape memory alloy rotary actuator

U.S. Pat. No. 6,538,892B2* 2001 May. 25 Graftech Inc. Radial finned heat sink

1. A heat cycle/transfer engine, comprising:
a housing, consisting of a heat source side and a heat sink side, which may have an insulating layer between the two sides;
a sealed, tubular, approximately L shaped chamber, within the housing;
a working fluid, contained within the sealed chamber;
a rotary crank shaft-displacer cam combination, which moves the working fluid from the heat source side to the heat sink side and vice versa, in a repeated cycle;
a set of bearings, of a size dependent on the overall size of the housing, which support the rotary crank shaft-displacer cam combination;
a piston, situated perpendicular to the crank shaft-displacer cam combination, that causes or reacts to the expansion and contraction of the working fluid;
a connecting rod, that attaches the piston to the crank shaft-displacer cam combination, allowing the synchronous movement of the piston and the crank shaft-displacer cam combination;
the synchronous movement allowing the expansion and contraction of the working fluid to coincide with exposure of the working fluid to the corresponding heat source side and heat sink side, respectively, thereby utilizing the Carnot Heat Cycle to drive the piston, thereby driving the crank shaft-displacer cam combination, and providing rotary motion generation.

2. A heat pump, comprising;
a housing, consisting of a heat source side and a heat sink side, which may have an insulating layer between the two sides;
a sealed, tubular, approximately L shaped chamber, within the housing;
a working fluid, contained within the sealed chamber;
a rotary crank shaft-displacer cam combination, which moves the working fluid from the heat source side to the heat sink side and vice versa, in a repeated cycle;
a set of bearings, of a size dependent on the overall size of the housing, which support the rotary crank shaft-displacer cam combination;
a piston, situated perpendicular to the crank shaft-displacer cam combination, that causes or reacts to the expansion and contraction of the working fluid;
a connecting rod, that attaches the piston to the crank shaft-displacer cam combination, allowing the synchronous movement of the piston and the crank shaft-displacer cam combination;
the synchronous movement allowing the expansion and contraction of the working fluid to coincide with exposure of the working fluid to the corresponding heat source side and heat sink side, respectively, thereby utilizing the Carnot Heat Cycle to transfer heat from the heat source side to the heat sink side as a heat pump.

3. A rotary displacer cam, where the cam moves a fluid within a chamber.

4. A shape memory alloy rotary clutch, where a temperature change may release a clutching ring from the rotary body.

5. A heat cycle/transfer engine, of claim 1, where the piston may be substituted by a tympanic drum.

6. A heat cycle/transfer engine, of claim 1, where the initial startup motion may be provided by a secondary rotary source consisting of a looped coil of Nitinol, or similar shape-memory alloy, which encompasses the crank shaft-displacer cam combination, exposing it to the heat source side, at one extreme, and which also encompasses a rotary pin positioned in the heat sink side, at the other extreme, exposing it to the heat sink.

7. A heat pump, of claim 2, where the piston may be substituted by a tympanic drum.

8. A heat pump, of claim 2, where the transfer of heat does not depend on any initial temperature differential between the heat source side and the heat sink.
